(19) United States
(12) Patent Application Publication
(10) Pub. No.: US 2006/0115551 A1
(43) Pub. Date: Jun. 1, 2006

(54) Injection-mold pin

(75) Inventor: Dieter Peukert, Halver (DE)

Correspondence Address: THE FIRM OF KARL F ROSS, 5676 RIVERDALE AVENUE, PO BOX 900, RIVERDALE (BRONX), NY, 10471-0900, US

(73) Assignee: HASCO-Normalien Hasenclever GmbH & Co.

(21) Appl. No.: 11/289,757

(22) Filed: Nov. 29, 2005

(30) Foreign Application Priority Data
Nov. 30, 2004 (DE) 102004057945.8
Nov. 21, 2005 (DE) 102005055807.0

(51) Int. Cl. B29C 45/38

(52) U.S. Cl. 425/468; 425/577

(57) ABSTRACT

A mold defining a cavity has a pin guide extending into the cavity. This pin has a center rod having an outer surface and made of a highly thermally conductive material and a jacket sleeve of steel fitted over the rod and having an inner surface bonded gaplessly with the rod outer surface.

### FIELD OF THE INVENTION

The present invention relates to a pin for a mold. More particularly this invention concerns a core or knockout pin for a mold of system for injection-molding plastic.

### BACKGROUND OF THE INVENTION

It is standard for a mold to have one or more core pins that form blind or throughgoing holes in the workpiece being molded or one or more knockout pins that are pressed against the workpiece piece after the parts of the mold are separated to expel the finished workpiece from the mold. To this end the mold is typically formed for each such pin with a guide bore through which the pin extends and the pin is displaceable relative to the mold in the guide.

In a standard injection mold there are typically coolant passages through which a normally liquid coolant is passed so as to cool and cure the workpiece. The faster the workpiece is cooled, the more quickly the mold can be cycled, so that the production rate is largely a function of cooling speed. Clearly it is necessary to cool the entire workpiece before opening the mold and knocking the workpiece out of the mold, or the workpiece will be deformed and spoiled.

Since it is impossible to circulate the coolant through the normally relatively small-diameter pin or pins, it is known (e.g. see the ejector pins of Drei-S-Werk of Schwabach, Germany) to make them of a material with a very high thermal conductivity, e.g. a CuBe alloy. This material is, however, very difficult to machine. In addition it is attacked by some synthetic resins, for instance fire-resistant plastics. Furthermore CuBe alloys are not very strong, so that the pins require frequent replacement.

German 196 32 507 describes a knockout pin fitted to an axial bore of a sleeve. This system only serves to make it possible to switch out worn parts, and there is no difference in thermal conductivity. Similarly WO 94/26496 describes a knockout pin fitted in an axial bore of a knockout sleeve. The goal here is to reduce wear of the knockout pin by providing a tapering bore in the knockout sleeve. Once again, there is no heat-transmitting function.

In order to make an improved pin, it has been suggested to fit a steel jacket with a copper core. This was done by thermally shrinking the copper core so that it could fit in the steel tube, then allowing the temperatures of the core and the jacket to equalize so that the outer surface of the core presses outward against the inner surface of the jacket. This does not, however, produce a full-length metallic bonding at the molecular level between the core and jacket. Such a rod is typically produced in very long lengths, and then is cut by the actual end user of it to the desired much shorter lengths. Due to the inadequate bonding, the cut end of such a shorter length is not perfectly smooth and planar, but will have pits or recesses that are particularly disadvantageous when the rod is used as a knockout pin by driving its end against a still somewhat soft freshly molded workpiece, since it will produce a mark on the workpiece.

German 44 39 984 describes molds for making metal, plastic, or glass bodies where the inner surface is partially formed of a laminate. The actual surface is made of a material of reduced conductivity but high resistance to thermal shock and abrasion. Making such a laminate in a very complex shape is extremely difficult. Similarly, German utility model 694 03 513 describes an injection-molding machine whose torpedo is formed of an outer steel sleeve and a core of copper.

### OBJECTS OF THE INVENTION

It is therefore an object of the present invention to provide an improved injection-mold pin.

Another object is the provision of such an improved injection-mold pin that overcomes the above-given disadvantages, in particular that is fairly strong and resistant to thermal shock and abrasion, yet which is highly thermally conductive.

### SUMMARY OF THE INVENTION

In combination with a mold defining a cavity and having a pin guide extending into the cavity, a pin has according to the invention a center rod having an outer surface and made of a highly thermally conductive material, and a jacket sleeve of steel fitted over the rod and having an inner surface bonded gaplessly with the rod outer surface.

Thus the pin according to the invention, which can be a core pin around which plastic is molded or a knockout pin used to eject the workpiece from the mold, has a full- or partial-length core of highly conductive metal, which is typically relatively fragile, while the outer surface or jacket is formed of a material with excellent resistance to abrasion or thermal shocks. The rod according to the invention is easy to manufacture, as the outer steel jacket can easily be machined to high tolerances.

The intimate interconnection of the rod and the jacket makes the pin according to the invention ideal for use both as a core pin and as a knockout pin. Even if the rod is made up in long pieces that are subsequently cut to the desired short lengths by the mold fabricator, the cut plane will be clean with no gaps between the center rod and the jacket due to the bond between them. The material of the center rod and the material of the jacket bond unitarily together at the molecular level to form a metallic bond that is permanent and that has no gaps whatsoever.

The invention uses the method of German 102 29 994 of Mecobond Dr. Betz GmbH. This method completely eliminates the problems of the prior art joining metals with different coefficients of thermal expansion. With this matter cooling of the two components produces a pressure that exceeds the stretch limit of at least one of the two components so that it is plastically deformed at least at the molecular level. The pressure can be directed purely at one of the two materials, for example at the copper or copper-containing core.

The Mecobond process from German '994 does not relate to the manufacture of a mold core or knockout pin. It describes solely the material-bonding system of at least two materials with different thermal expansion coefficients. According to it, the two materials are first heated and then cooled. During the cooling the materials pass through a temperature at which the two materials are in very tight contact with each other and as they pass through this temperature an isostatic pressure is produce that is grater than the thermal-stretch limit of at least one of the materials, so that this material is plastically deformed at least at the molecular level.

According to the invention the center rod is made at least partially of copper. Copper has extremely good thermal conductivity so that heat is optimally conducted away from problematic zones of the mold. In this manner the mold can be uniformly cooled. The core can be pure copper or copper alloyed with another metal, e.g. beryllium, having good heat-conducting properties.

In accordance with the method defined in above-cited German '994 the outer and inner surfaces are unitarily and metallically bonded to each other by a high-temperature, high-pressure metal-diffusion process conducted by first heating to a temperature between 850° C. and 1200° C. (above the melting point of the center rod) and then a pressure between 10×10⁵ pa and 5000×10⁵ pa is applied as they are cooled.

According to the invention the rod and the sleeve have planar inner end faces normally in the cavity and normally coplanar. A seal layer covers at least the inner end face of the center rod and seals the rod inside the sleeve. This layer can be produced by laser welding. Alternately the seal layer is a steel disk bonded to rod and jacket at the inner end faces. This way the alloy core is protected from some of the more corrosive resins that might be used in the mold.

The mold in accordance with the invention is formed adjacent the pin with coolant passages. Thus the region of the mold holding the pin is actively cooled so that the highly conductive core of the pin will also be cool. Similarly when the pin is a core pin, it will serve to conduct heat out of the workpiece, thereby cutting cooling time.

The inner surface of the jacket according to the invention extends a full axial length of the sleeve. The outer surface is bonded gaplessly with the rod outer surface over a full axial length of the rod. In this embodiment there can be a full-length center rod for full-length heat transmission from the pin.

It is also within the scope of this invention for the outer surface to be bonded gaplessly with the rod outer surface over only a portion of a full axial length of the rod. In fact the center rod can only extend over a portion of the jacket, where heat exchange is needed.

Furthermore in accordance with the invention the sleeve has an outer diameter of at least 10 mm. Since copper and most copper alloys have nothing like the strength of steel, this dimension ensures that the pin according to the invention is strong enough.

### BRIEF DESCRIPTION OF THE DRAWING

The above and other objects, features, and advantages will become more readily apparent from the following description, reference being made to the accompanying drawing in which:

FIG. 1 is an axial section through a mold assembly according to the invention;

FIG. 2 is a larger-scale side view of the core pin according to the invention; and

FIG. 3 is a yet larger-scale section through the detail indicated at III in FIG. 2.

### SPECIFIC DESCRIPTION

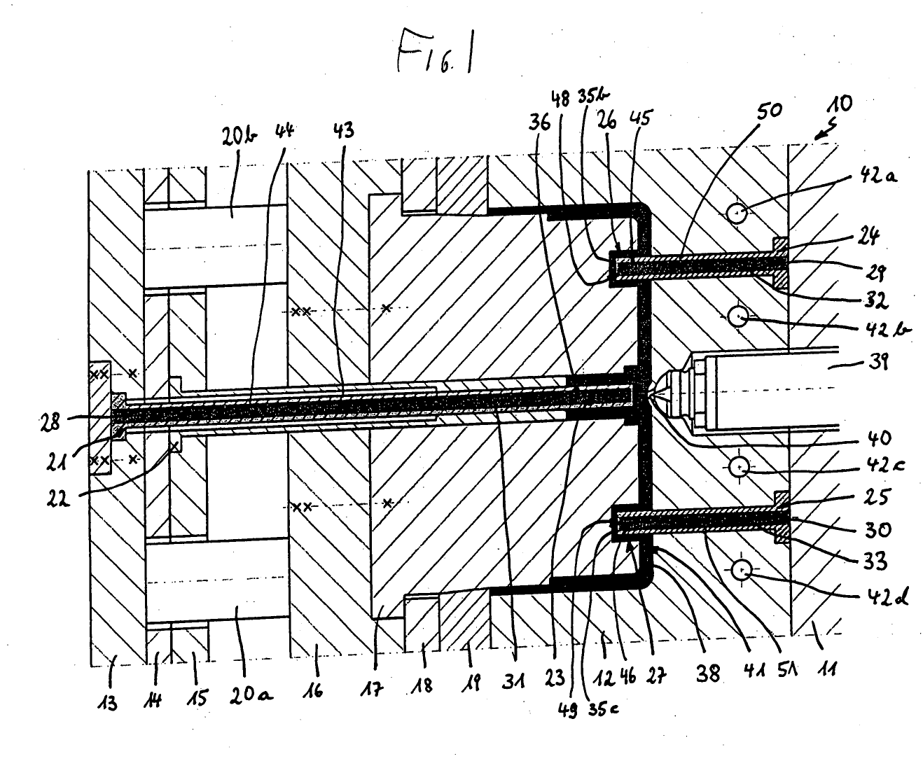

As seen in FIG. 1 a mold 10 according to the invention has a mounting plate 11 to which is normally secured a female mold part or plate 12. On the opposite side is another mounting plate 13, two knockout plates 14 and 15, another mold plate 16, and a male mold part or plate 17 forming with the female part 12 a cup-shaped mold cavity 41. Posts 20a and 20b support the mold plate 16 and part 17, a plate 18 secures the mold part 17 to the plate 16, and a stripper plate 19 is fixed to the plate 16 and closes the end of the cavity 41. A core pin 21 of at least 10 mm outside diameter is fixed to the mounting plate 13 and projects through the knockout plates 14 and 15, through the old plate 16, and through the mold part 17 so that its inner end 36 engages in the cavity 41. A molded workpiece 38 formed in the cavity 41 is formed by the pin 23 with a blind bore or hole 23.

A knockout sleeve 22 coaxially surrounds the pin 21 and can slide relative thereto. A gap 43 between the outer surface 22 of the pin 22 and the inner surface of the sleeve 22 facilitates easy relative movement of these two parts. It serves to knock the workpiece 38 off the male part 17 when the mold assembly 10 is opened. To this end the plates 14 and 15 with the knockout sleeve 22 are shifted to the right as seen in FIG. 1 as the mold plates 16 and 17 are shifted to the left.

The female mold part 12 is provided with a pair of core pins 24 and 25 used to form pockets 26 and 27 in the end face of the cup-shaped workpiece 38. To this end ends 45 and 46 of the pins 24 and 25 project into the cavity 41. The pin 21 comprises a cylindrically tubular outer jacket 44 of steel having a full-length cylindrical axial bore or passage 28. A center rod 31 of copper is fitted to the bore 28. Similarly the pins 24 and 25 have jackets 50 and 51 with axial bores 29 and 30 that receive respective center rods 32 and 33. The pins 21, 24, and 25 are identical except for length and some minor variations in diameter.

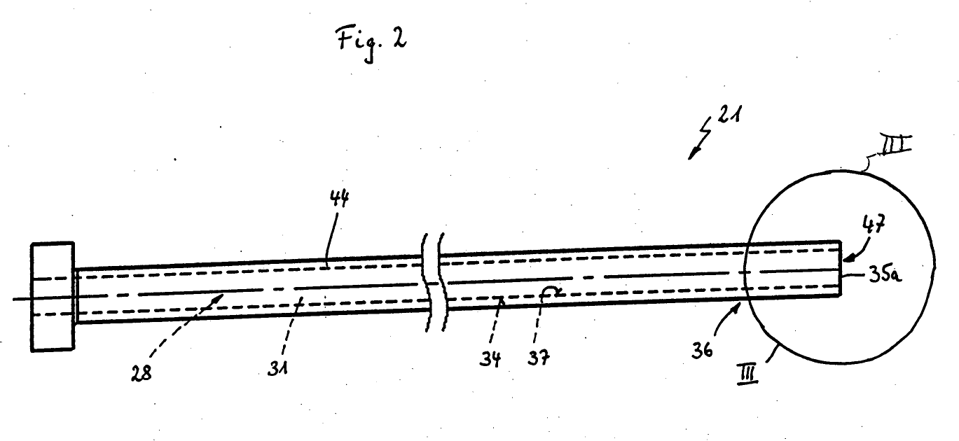

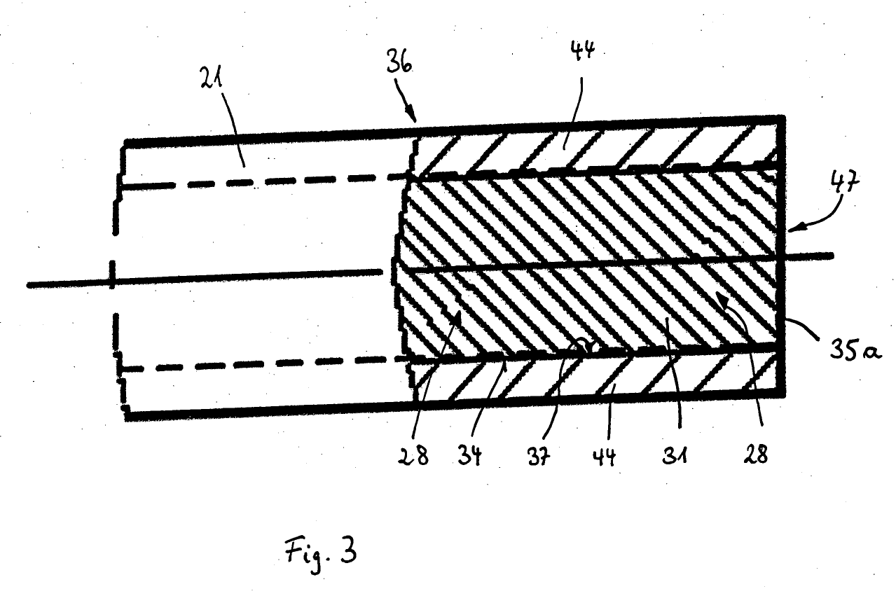

FIGS. 2 and 3 show the core pin 21 in detail. Its center rod 31 has an outer surface 34 that is unitary with an inner surface 37 of the jacket tube 44. This intimate surface bonding is achieved according to the above-discussed process from German '994. More particularly the surface bonding is produced by the above-discussed Mecobond process. In this process the center rod 31 of copper is subjected to pressure beyond its stretch limit so that it is plastically deformed at least at the molecular level and enters into a gapless metallic union with the steel jacket 44. The center rod 31 of copper imparts to the pin 21 very good heat-conducting capacity. The jacket 44 of steel makes the pin very resistant to abrasion.

As further shown in FIG. 1, the mold 10 has at the center of the cavity 41 an inlet port 40 to which is fitted an extruder nozzle 39 for injecting plastic under pressure into the cavity 41. Coolant passages 42a, 42b, 42c, and 42d in the mold part 12 are close to the core pins 24 and 25 so that they remain fairly cool, especially as their center rods 32 and 33 are highly heat conductive and in intimate heat-exchange contact with their sleeves 50 and 51. Similar passages can be formed in the mold part 17 or the outer end of the rod 21 can be air cooled.

In order to prevent the often corrosive molten plastic from contacting the center rods 31, 32, and 33, outer ends 47, 48, and 49 of the bores 28, 29, and 30 are sealed at 35a, 35b, and 35c. This can be done by laser welding or by brazing or welding a steel disk to the end faces.

I claim:

1. In combination with a mold defining a cavity and having a pin guide extending into the cavity, a pin comprising:
a center rod having an outer surface and made of a highly thermally conductive material; and
a jacket sleeve of steel fitted over the rod and having an inner surface bonded gaplessly with the rod outer surface.

2. The combination defined in claim 1 wherein the center rod is made at least partially of copper.

3. The combination defined in claim 2 wherein the outer and inner surfaces are unitarily bonded by metallic connection to each other.

4. The combination defined in claim 1 wherein the rod and the sleeve have coplanar inner end faces normally in the cavity, the combination further comprising
a seal layer covering the inner end faces and sealing the rod inside the sleeve.

5. The combination defined in claim 4 wherein the seal layer is a steel disk bonded to the inner end faces.

6. The combination defined in claim 1 wherein the mold is formed adjacent the pin with coolant passages.

7. The combination defined in claim 1 wherein the inner surface extends a full axial length of the sleeve.

8. The combination defined in claim 7 wherein the outer surface is bonded gaplessly with the rod outer surface over a full axial length of the rod.

9. The combination defined in claim 7 wherein the outer surface bonded gaplessly with the rod outer surface over a portion of a full axial length of the rod.

10. The combination defined in claim 1 wherein the sleeve has an outer diameter of at least 10 mm.
